(19) United States
(12) Patent Application Publication
(10) Pub. No.: US 2022/0303716 A1
(43) Pub. Date: Sep. 22, 2022

(54) METHOD FOR ESTIMATING THE NUMBER OF PEOPLE PRESENT IN A GIVEN GEOGRAPHICAL AREA

(71) Applicant: INSTITUT MINES TELECOM, Palaiseau (FR)

(72) Inventors: Hossam AFIFI, Paris (FR); Michel MAROT, Villebon-sur-Yvette (FR)

(21) Appl. No.: 17/636,509

(22) PCT Filed: Jul. 31, 2020
(86) PCT No.: PCT/EP2020/071728

§ 371 Date: Feb. 18, 2022

(30) Foreign Application Priority Data
Aug. 19, 2019 (FR) FR1909258

(51) Int. Cl. H04W 4/021; H04W 24/08; H04W 74/08; H04W 64/00

(52) U.S. Cl. CPC H04W 4/021; H04W 24/08; H04W 74/0833; H04W 64/006

(57) ABSTRACT

Method for estimating the number of people present within a given geographical area, with at least a portion of the people being equipped with cellular terminals that communicate according to at least two predefined communication standards. The method includes the steps of: (a) using a traffic analysis on the one or more networks present in the predefined area, carried out using at least one traffic analyzer located in the area and with a range chosen according to the area to be covered, detecting, for each of the standards, at least one indicator that represents the activity of a terminal on the network(s) and operating according to at least the same standard, (b) deducing the indicators thus detected, counting the number of cellular terminals present in the area, (c) estimating the number of people present in the area, using at least one law of correlation between the number of cellular terminals thus counted and the corresponding number of people present in the area.

The present invention relates to a method for estimating the number of people present in a given geographical area and to a device for implementing this method.

### PRIOR ART

One possible method for performing a people count is to count them manually. This method is used in particular to evaluate the occupancy level of a train formation, but is tedious and requires at least one human operator.

Methods for evaluating road traffic using systems of cameras or induction loops are also known. These methods require significant investments to be set up, and the system cannot easily be moved once it has been set up.

Finally, methods for accurately counting the number of terminals connected to a given cellular network at a given time are possible in theory, but are only able to be implemented by the telephony operators operating on this network. Specifically, only these are able to access the exact number of connections to a base station of a cell of the network at a given time. This method is not used in practice since it is very expensive to set up, given the large number of base stations that a network contains. Telephony operators instead carry out a count based on call reports. Since this solution is linked to the operator, it gives very limited sampling that is moreover linked to the base stations.

One method for the real-time monitoring of the evolution of the urban population is disclosed in the publication Real-time urban population monitoring using pervasive sensor network drafted by Thakur et al. This method is based on measuring the number of Cell Radio Network Temporary Identifiers (C-RNTI for short) allocated in a cell around a base station. This method has multiple disadvantages. First of all, it makes it possible to recognize only users of the LTE standard. Next, the area where the count is performed is necessarily that covered by a cell of a base station of a telephony operator, thereby limiting the choice and the extent of the area where the count is performed.

### DISCLOSURE OF THE INVENTION

There is therefore a need to benefit from a method for estimating the number of people in a given geographical area that is independent of telephony operators, that is to say that does not require access to data belonging to these operators, and that is easy to implement.

### SUMMARY OF THE INVENTION

The invention aims to address this need and does so, according to one of its aspects, by virtue of a method for estimating the number of people present in a given geographical area, at least some of these people being equipped with cellular terminals communicating on at least one network, the terminals communicating in accordance with at least two predefined communication standards, the method comprising the steps of:

(a) detecting, from an analysis of the traffic on the one or more networks present in said predefined area, performed using at least one traffic analyzer located in this area and with a range chosen depending on the area to be covered and for each of said standards, at least one indicator representative of the activity of a terminal on this or these one or more networks and operating in accordance with at least this standard,

(b) deducing, from the indicators thus detected, a count of the number of cellular terminals present in the area,

(c) estimating the number of people present in said area, based at least on a correlation law between the number of cellular terminals thus counted and the corresponding number of people present in said area.

The invention is based on estimating a number of cellular terminals in an area chosen by the user, separate from the cells of the base stations belonging to the telephony operators.

The invention makes it possible to easily estimate a number of people present in a given area based on the number of cellular telephones that are present. In particular, this method makes it possible to automatically evaluate the number of people in an area without requiring an individual to be present in the area to perform this count.

The invention makes it possible to estimate the occupancy level of a location, for example a stadium. It also makes it possible to detect the movement of people through a space or the holding of an exceptional event bringing together multiple people in one and the same location.

One of the advantages of the method according to the invention is that it makes it possible to count the cellular terminals independently of the standard in accordance with which they communicate. The network analyzer (or “sniffer”) is able to listen to traffic on the frequency bands of each of the communication standards. This analyzer is able to read the information obtained from the network and that transmitted by cellular and wireless terminals. The data from the analyzer may be processed via software by any suitable data processing circuit, comprising a processor, for example a microcomputer or a dedicated card. The software-based data processing makes it possible to analyze messages transiting on the network and to determine the nature of these messages. When the messages are not encrypted, such as random access requests for example, it is possible to read the data transmitted by the message.

It is then possible to recognize various indicators that are counted in order to evaluate the number of cellular terminals present in the geographical area. It is for example possible to count the number of connection procedures that take place on the network.

The traffic analysis may comprise, as mentioned above, detecting an indicator corresponding to a request for random access to the network from a cellular terminal.

This indicator is particularly easy to recognize for the network analyzer since, in mobile telephony standards, random access requests are not encrypted. It is thus easy to count them and estimate the number of cellular terminals in the area that are connected to a base station.

It is advantageously possible to identify, for each standard, at least one indicator and thus to identify for example other indicators, such as the identifiers of the cellular terminals transiting on the network, such as the CRNTI, TLLI or P-TMSI identifiers.

The number of cellular terminals might not correspond exactly to the number of people present in the area, and this will often be the case in practice, from a statistical point of view. Specifically, all of the people present in the area do not necessarily use the network, nor do they use it at the same time. Moreover, the method does not make it possible to detect when a person leaves the area. It is therefore necessary to rely on a correlation law between the number of people actually present and the number of cellular terminals counted in the area in order to be able to deduce, from the counted cellular terminals, an estimate of the number of people actually present in the area. This correlation law results from a prior observation of reality, or is established by analogy with similar situations, for example from a statistical point of view.

As a variant or in addition, the traffic analysis comprises detecting an indicator corresponding to a response to a random access request from a cellular terminal.

Counting the responses to the random access requests from the cellular terminals makes it possible to make the count of the random access requests performed by the network analyzer more reliable. These response messages are not encrypted. If the two counts that are performed are equal, then the risk of an error having occurred in the counts is reduced.

In order to obtain a more reliable result, preferably only the responses to the random access requests from the cellular terminals that have been identified beforehand by the network analyzer are counted.

The correlation law may have been generated from the observation of real data, in particular by training a neural network.

It is possible to supply, at input of the neural network, a dataset corresponding to the number of people actually present in the area, and another set corresponding to the count of the number of cellular terminals performed during the implementation of the method. The neural network may then deduce, from the various datasets, that it is successively supplied with a correlation law that makes it possible to link the two datasets. Following this training, it is possible to deduce, from the number of cellular terminals counted by the network analyzer, an estimate of the number of people present by applying the correlation law thus generated. The neural network thus makes it possible to correct the measurements performed by the network analyzer.

The data used for training stem for example from image analysis and/or a manual count.

To establish the dataset corresponding to the number of people actually present in the area, it is possible to perform an actual count of the people present in the area, for example through manual counting, as is performed in rail transport, or using cameras or any other counting means. For example, during a given period, the number of people present in a train formation is counted manually every Monday between 8 a.m. and 9 a.m., and the number of terminals detected is recorded by implementing the detection method according to the invention. This gives a correlation law between the number of terminals detected and the number of people, which may then be used to estimate the occupancy of the train at any time.

Advantageously, the traffic analysis is performed without prior decryption of the data transiting on the networks under analysis.

The network analyzer identifies all unencrypted messages and transmits them to the data processing circuit. In the various standards in accordance with which cellular terminals communicate, random access requests and responses to these requests are transmitted in open form to the base station of the cell where the cellular terminals are located. The network analyzer may therefore easily identify them and transmit them to the data processing circuit in order to estimate the number of cellular terminals present in the area. It is therefore not necessary to decrypt the messages in order to estimate the number of cellular terminals. The method that is the subject of the invention may therefore be implemented independently of telephony operators. In particular, the method that is the subject of the invention may make it possible to estimate a number of cellular terminals present in a given geographical area without having access to the identifiers of the cellular terminals, such as for example the IMSI (International Mobile Subscriber Identity) number.

The network analyzer may be placed in any desired position, independently of the distribution of the cells and the base stations. The network analyzer may be mobile. It may thus be easily moved and placed in any location where it is desired to estimate the number of people present.

The network analyzer comprises a receiver that is separate from the transceiver of a base station. Since the network analyzer is not linked to a base station, the cellular terminals that are detected do not belong to a single telephony operator. The network analyzer may be positioned such that the limits of its area of coverage are not coincident with the limits of the area of coverage of a base station. For example, the network analyzer is placed such that its area of coverage is located between the cells of multiple base stations. As a variant, it may be placed such that its area of coverage is contained within a cell of a base station.

The predefined communication standards are for example chosen from among the following: 2G, in particular GSM, 2.5G, 3G, in particular UMTS, 4G, in particular LTE, 5G, Wi-Fi, Bluetooth.

If at least one of the cellular terminals communicates in accordance with a 2G communication standard on the network, the indicator counted during the analysis may be the number of RR IMMEDIATE ASSIGNMENT messages sent by a base station in response to the random access requests identified on the network.

In 2G, a random access request assumes the sending of a burst of data on the RACH (Random Access Channel) channel. This burst of data is accessible on the channel in open form. After this, if there is no collision, an RR IMMEDIATE ASSIGNMENT message is sent on the AGCH (Access Grant Channel). This last message is not encrypted, and contains connection information required to describe the channel to be used to communicate, such as for example the frequency of the carrier or the assigned slot number.

Access to the resource is required in order to initiate a call, but also in other situations, such as for example following a search for a person (“paging”) or during a location update. After paging, a random access procedure has to take place, in the same way as for a normal outgoing call. Location updates are performed either periodically or in an event-based manner. They require a radio channel to be established, and therefore also require a random access procedure. In a location update procedure, the base station transmits an RR IMMEDIATE ASSIGNMENT, the cellular terminal in return transmits an MM LOCATION UPDATING REQUEST in open form on the channel indicated in the RR IMMEDIATE ASSIGNMENT message.

On the other hand, in the event of inter-cell transfer (or “handover”), the information on the channel in the target cell, that is to say the cell to which the user changing cell is heading, is not transmitted in open form, and there is no provision for any random access procedure. It is therefore not possible to track the departure or arrival of a client during a handover.

If at least one of the cellular terminals communicates in accordance with a 2.5G communication standard on the network, the indicator counted during the analysis may be the number of PACKET UPLINK ASSIGNMENT messages sent by a base station in response to the random access requests identified on the network.

In 2.5G, access to the network requires the reservation of either static or dynamic resources, and random access beforehand, except in the case of a downlink call. Random access takes place on the RACH or PRACH (Physical Random Access Channel) channel with a PACKET CHANNEL REQUEST transmitted by the cellular terminal, and is followed by the transmission of a PACKET UPLINK ASSIGNMENT on the PAGCH by the base station. The exchanges before the cellular terminal is authenticated are not encrypted. It is therefore possible to measure the number of PACKET UPLINK ASSIGNMENTs that are transmitted in the area.

In the case of establishing a downlink flow, that is to say from the base station to the cellular terminal, access may take place without paging (case of a mobile in the READY state) or with paging (case of a mobile in the STANDBY state). With paging, a random access phase of the cellular terminal is required. Without paging, the base station sends a PACKET DOWNLINK ASSIGNMENT directly to the cellular terminal on the PAGCH. In principle, this message should be encrypted, but this is not always the case depending on the operator and the country. It is also possible to measure PACKET DOWNLINK ASSIGNMENT in order to estimate the number of cellular terminals in an area.

If no message is encrypted, the activity indicator that may be counted during the traffic analysis may be the number of TLLI or P-TMSI identifiers. These identifiers are obtained from the phases in which the cellular terminal attaches to the network, and updated by reading the PACKET RESOURCE REQUEST on the PACCH, PACKET UPLINK ASSIGNMENT on the PACCH, PACKET UPLINK Ack/Nack on the PACCH and the PACKET DOWNLINK ASSIGNMENT of the PAGCH.

If at least one of the cellular terminals communicates in accordance with a 3G, 4G and/or 5G communication standard on the network, the indicator counted during the analysis may be the number of RRC CONNECTION SETUP messages sent by a base station in response to the random access requests identified on the network.

In 3G, 4G and 5G, RRC connections assume a random access procedure either on the RACH or on the PRACH. An RRC connection is in particular performed for network registration, for some cases of LOCATION UPDATING localization or for detachment from the network.

In 3G standards, handovers are difficult to detect, since the carrier frequencies are given in an encrypted message. On the other hand, in 4G standards, random access is also required when there is a handover. It is therefore possible to detect handovers when a cellular terminal communicates in accordance with a 4G standard.

If at least one of the cellular terminals communicates in accordance with the Wi-Fi communication standard on the network, the indicator counted during the analysis may be the number of (association-request, probe-request) messages and/or the number of different MAC addresses connected to this network.

In the Wi-Fi 802.11 standard, the access point broadcasts periodic messages, called beacons, which it sends to the terminals. The terminals may be cellular, such as for example mobile telephones, or non-cellular, such as for example computers. The terminals respond to the beacons with association requests. The access points, which do not broadcast beacons, are called upon by ‘probe-request’ messages that are transmitted by the terminals. The access points are obligated to respond to these calls. This association request procedure is unencrypted. The response to an association request ‘association response’ may be encrypted. The headers of the frames flowing on the network are visible to the network analyzer. This may deduce therefrom the presence and an estimate of the number of equipments, and also the type of equipment, for example cellular or non-cellular.

Advantageously, the method that is implemented is tailored to the infrastructure, ad-hoc (also including Wi-Fi Direct) and Mesh (each station transmits specific beacons) modes of the Wi-Fi network.

The count of the number of terminals connected to a Wi-Fi network may make it possible to make the performed estimate of the number of people more reliable. In particular, counting the connections of the terminals to cellular networks and to Wi-Fi terminals in parallel makes it possible to have two datasets from which the number of people is estimated.

It is possible for example to supply the dataset corresponding to the count of the number of terminals connected in Wi-Fi mode to the abovementioned neural network in order to enrich the model and refine the generated correlation law.

Moreover, in order to improve the people count, it is possible to detect the activity of terminals transmitting and/or receiving signals in accordance with one of the Bluetooth standards in the geographical area and acquire a corresponding Bluetooth dataset. The neural network may be supplied with this Bluetooth dataset.

Advantageously, the traffic analyzer comprises at least one antenna, the gain and/or the directivity of this antenna being chosen so as to cover the given geographical area.

It is possible to determine the geographical area in which the number of people is estimated by adjusting the position of the network analyzer and its range. The range of the receive antenna of the analyzer may be modified by modifying its power and its directivity. The area of coverage of the network analyzer is thus able to be configured. The reception power of the antenna may be adapted so as to limit the reception area. It is thus possible to perform a localized count.

It is possible to select the gain of the antenna of the receiver and its directivity in order to extend the radius of coverage of the area to a greater or lesser extent. However, it may prove difficult to establish a direct relationship between geographical coverage and power of the receive antenna independently of the position of the base station of the network and the configuration of the locations. Specifically, cellular terminals transmit with a higher or lower power depending on the proximity to a base station and on the density of the network. It may therefore be useful to perform preliminary calibration of the network analyzer depending in particular on the scenarios under consideration and/or on the location chosen when implementing the method according to the invention.

The count of the number of indicators representative of the activity of a mobile terminal is performed incrementally during the measuring period.

The one or more indicators representative of the activity of a terminal are thus detected for example continuously for a given measurement time, during which the count of the number of indicators is incremented; the method may comprise a step of decrementing this count when the measurement time has elapsed.

The traffic analysis that is performed does not make it possible to detect when a person leaves the cell without having released the busy channel. This is in particular the case during a handover. The traffic analysis that is performed also does not make it possible to detect the case where a person releases a channel before leaving the area. Specifically, the messages sent when the radio channel is released are encrypted, and they are therefore not able to be detected by the analyzer. It may therefore be useful to decrement the count of the number of indicators representative of the activity of a mobile terminal between two measuring periods.

The count of the number of indicators representative of the activity of a terminal may be decremented by reinitializing the count.

The indicator count may be reinitialized periodically, for example by setting it to zero. When the decrementation is performed discontinuously over time for the total duration of traffic analysis, reference may be made to a “jumping window” mechanism.

The count of the number of indicators representative of the activity of a terminal may also be decremented by decrementing this count by a predefined number.

For example, the count of the number of terminals may be decremented by one after a predetermined duration following the detection of a person in an area. The duration may be fixed or determined by a random law. For example, there is a systematic decrementation by one every minute.

In this embodiment, it is considered that any person whose presence is detected disappears after a determined duration. This duration may be fixed or determined by a random law. When the decrementation is performed continuously over time for the duration of the traffic analysis, reference may be made to a “sliding window” mechanism.

The given geographical area is for example a moving area, in particular a train formation and/or a bus.

The method according to the invention may make it possible to estimate the occupancy level of a train formation. For example, the network analyzer is placed in the train formation, and the gain of the antenna is adjusted in order to delineate the area to the train formation only.

The given geographical zone may also be a non-moving area, in particular a station, a stadium and/or a plaza.

The network analyzer may thus be placed in a station in order to estimate the usage of the station or of a line passing through this station.

The method that is the subject of the invention may make it possible to estimate the occupancy level of a public location, such as for example a stadium, an exhibition space or the like. This method may also be used to estimate the number of people attending a demonstration, for example by placing it in a plaza or in a street.

The method according to the invention may be applied in order to track a flow of people. By comparing the estimated number of people in nearby areas, it is possible to deduce therefrom a movement of people between these areas. To implement this method, it is possible to ensure that multiple network analyzers transmit the estimated number of people in their area to one and the same data processing circuit, which performs the comparison and derives therefrom information relating to the flow of people.

Another subject of the invention is thus a method for detecting a flow of people between at least two nearby geographical areas, a network analyzer being placed in each of the areas, the method comprising the steps of:
estimating the number of people present and/or cellular terminals in each of said areas by applying at the very least steps (a) and (b) of the method according to the invention,
comparing the estimated values in each of the areas in order to deduce therefrom the orientation and/or the intensity of the flow of people between the two areas.

Another subject of the invention, according to another of its aspects, is a device for estimating the number of people present in a given geographical area, at least some of these people being equipped with cellular terminals communicating on at least one network, the terminals communicating in accordance with at least two predefined communication standards, in particular for implementing the method according to the invention as defined above, the device comprising:
a local receiver comprising a traffic analyzer for listening to the traffic on at least one network and for determining the number and the nature of the unencrypted messages transiting thereon,
a circuit for processing data from the receiver, configured so as to:

(a) detect, from an analysis of the traffic on the one or more networks present in said predefined area, performed using at least the traffic analyzer located in this area and with a range chosen depending on the area to be covered and for each of said standards, at least one indicator representative of the activity of a terminal on this or these one or more networks and operating in accordance with at least one of said standards,

(b) deduce, from the indicators thus detected, a count of the number of cellular terminals present in the area,

(c) estimate the number of people present in said area, based at least on a correlation law between the number of cellular terminals thus counted and the corresponding number of people present in said area.

This device is able to acquire the radio signals that are within its range and thus detect the messages that are exchanged on the network. This device is in particular designed to scan one or more frequency bands, in particular the bands that correspond to the various mobile telephony standards.

The signals acquired by the local receiver are then transmitted to a data processing circuit. This circuit may in particular comprise a processor. This circuit is for example designed to analyze the acquired signals and detect indicators representative of the activity of a cellular terminal. For example, the circuit identifies the acquired connection requests and counts them.

The local receiver of the device according to the invention may comprise a universal software radio peripheral. This allows communication with the data processing circuit via a USB or Ethernet connection. The data processing circuit is for example a system comprising a processor, such as a microcomputer or a dedicated card. This data processing circuit may execute radio software in order to analyze the acquired radio signals.

The radius of coverage of the device may be able to be configured. It may be chosen depending on the geographical location and on the density of the network.

The device is compact and portable. It may easily be placed at any location.

Another subject of the invention, according to another of its aspects, is a vehicle or a public reception room equipped with an aforementioned device according to the invention, the antenna is for example configured such that its coverage substantially coincides with the extent of the area of the vehicle or the room receiving people.

### BRIEF DESCRIPTION OF THE DRAWINGS

The invention will be able to be better understood on reading the following detailed description of one non-limiting exemplary embodiment thereof, and on examining the appended drawing, in which:

FIG. 1 is a diagram of one implementation of the invention,

FIG. 2 is a schematic view of one example of a device according to the invention,

FIG. 3 is a block diagram of one example of a neural network used to implement the invention,

FIG. 4 is a graph illustrating one example of a result obtained following implementation of the method according to the invention,

FIG. 5 is a figure similar to FIG. 4.

### DETAILED DESCRIPTION

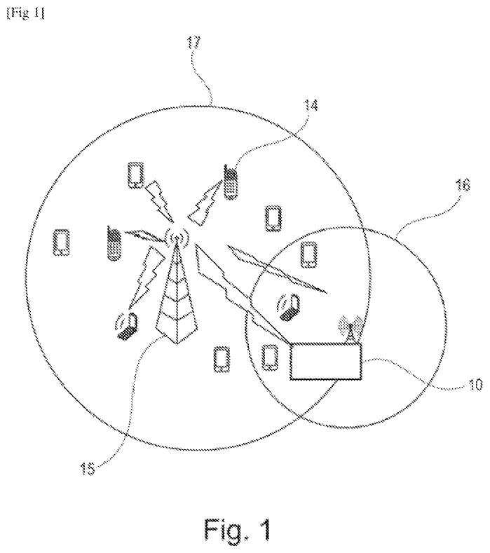

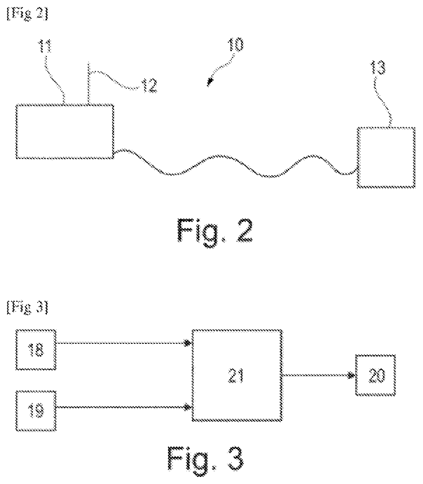

FIG. 1 illustrates one exemplary implementation of the method that is the subject of the invention. In this example, cellular terminals 14 are located in a cell 17 and communicate with a base station 15 of a mobile telephony network. The cellular terminals 14 are able to communicate in accordance with a 2G, 3G, 4G and/or 5G standard.

A device 10 according to the invention is positioned such that the intersection between its area of coverage 16 and the cell 17 of the base station 15 is non-zero. The area of coverage 16 of the device 10 may be completely contained or partially contained within the cell 17 of the base station 15.

The device 10 comprises a local receiver 11, for example a universal software radio peripheral. The receiver 11 comprises an antenna 12. The local receiver 11 is designed to listen to the messages exchanged on the frequency bands dedicated to mobile telephony. It detects in particular random access request messages and responses to these access requests. Random access requests are not encrypted, and are therefore available in open form over the air interface. On the other hand, the responses to these access requests may be encrypted.

The receiver 11 transmits the signals acquired during listening to a data processing circuit 13. Said circuit identifies the nature of the transmitted messages, in particular whether it is a random access request message or a response to such a request.

Analyzing the messages detected by the receiver 11 makes it possible to perform a count of the random access request messages and the responses to these requests. From this count, it is possible to deduce an estimate of the number of cellular terminals 14 present in the area of coverage 16 of the device 10.

The data processing circuit 13 may then apply a correlation law that links the number of cellular terminals detected in the area of coverage 16 and the number of people present in this area 16.

This correlation law has for example been generated by a neural network 21. The training of this neural network 21 is illustrated in FIG. 3. A dataset resulting from a real observation of the number of people in the area is supplied at input 18. This real observation is for example performed through image analysis or through manual counting. A dataset resulting from the estimate performed by the device 10 is also supplied at input 19. The neural network 21 is trained by supplying multiple datasets. The neural network 21 generates, at output 20, a correlation law that makes it possible to deduce an estimate of the number of people present in the area 16 from the estimated number of cellular terminals 14.

### Example

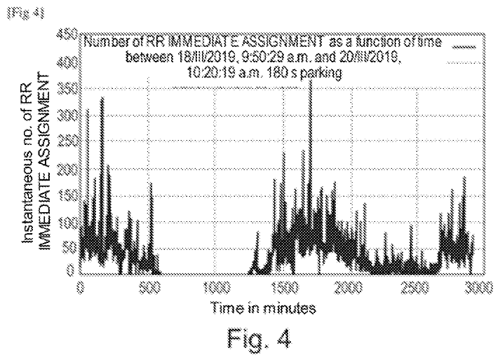

A test is performed by placing the device according to the invention in an exhibition location for two days. This device comprises a USRP National Instrument NI USRP-2920 universal software radio peripheral. The device is calibrated such that the area of coverage of the device corresponds to the extent of the location. On the first night, the location is closed to the public. By contrast, the second night precedes an exceptional event requiring preparations to be made during the night. The RR IMMEDIATE ASSIGNMENT messages in GSM mode, transmitted in the area of coverage, are detected and counted. FIG. 4 illustrates the evolution of the number of these messages as a function of time. An absence of messages detected during the first night, from Monday 18 March to Tuesday 19 March, is noted. On the contrary, activity is observed the following night. It is therefore possible to establish a link between the number of RR IMMEDIATE ASSIGNMENT messages and the presence of people in the location.

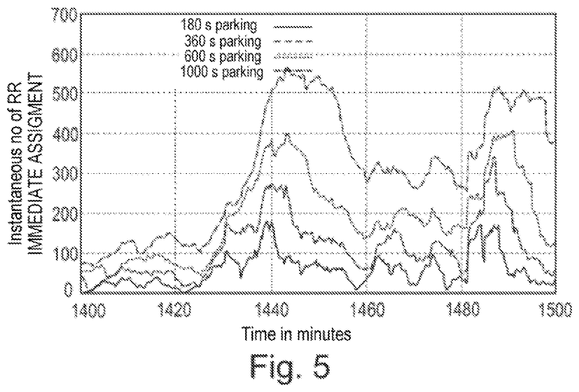

FIG. 5 is a graph showing the evolution of the number of RR IMMEDIATE ASSIGNMENTs detected as a function of time and for various parking times of the people (180 s, 360 s, 600 s, 100 s). It may be seen that the number of detected RR IMMEDIATE ASSIGNMENT messages varies with the fixed parking duration. It may therefore be useful to take this parameter into account when establishing the correlation law, in particular by supplying this parameter to the neural network if such a network is used to generate the correlation law.

Of course, the invention is not limited to the exemplary embodiments that have just been described. For example, the invention may be applied to communication standards, in particular telephony standards, other than those mentioned.

The expression “comprising a” should be understood to be synonymous with “comprising at least one”.

1. A method for estimating the number of people present in a given geographical area, at least some of these people being equipped with cellular terminals communicating on at least one network, the terminals communicating in accordance with at least two predefined communication standards, the method comprising the steps of:
(a) detecting, from an analysis of the traffic on the one or more networks present in said predefined area, performed using at least one traffic analyzer located in this area and with a range chosen depending on the area to be covered and for each of said standards, at least one indicator representative of the activity of a terminal on this or these one or more networks and operating in accordance with at least this standard,
(b) deducing, from the indicators thus detected, a count of the number of cellular terminals present in the area,
(c) estimating the number of people present in said area, based at least on a correlation law between the number of cellular terminals thus counted and the corresponding number of people present in said area,
the traffic analysis comprising detecting an indicator corresponding to a response to a random access request from a cellular terminal.

2. The method as claimed in claim 1, wherein the traffic analysis comprises detecting an indicator corresponding to a request for random access to the network from a cellular terminal.

3. The method as claimed in claim 1, wherein the correlation law is generated from the observation of real data.

4. The method as claimed in claim 1, wherein the data is used for the training stemming from image analysis and/or a manual count.

5. The method as claimed in claim 1, wherein the traffic analysis is performed without prior decryption of the data transiting on networks under analysis.

6. The method as claimed in claim 1, wherein the predefined communication standards are chosen from among the following: 2G, 2.5G, 3G, 4G, 5G, Wi-Fi, Bluetooth.

7. The method as claimed in claim 1, wherein at least one of the cellular terminals communicating in accordance with a 2G communication standard on the network, the indicator counted during the analysis is the number of RR IMMEDIATE ASSIGNMENT messages sent by a base station in response to the random access requests identified on the network.

8. The method as claimed in claim 1, wherein at least one of the cellular terminals communicating in accordance with a 2.5G communication standard on the network, the indicator counted during the analysis is the number of PACKET UPLINK ASSIGNMENT messages sent by a base station in response to the random access requests identified on the network.

9. The method as claimed in claim 1, wherein at least one of the cellular terminals communicating in accordance with a 3G, 4G and/or 5G communication standard on the network, the indicator counted during the analysis is the number of RRC CONNECTION SETUP messages sent by a base station in response to the random access requests identified on the network.

10. The method as claimed in claim 1, wherein at least one of the cellular terminals communicating in accordance with the Wi-Fi communication standard on the network, the indicator counted during the analysis is the number of (association-request, probe-request) messages and/or the number of different MAC addresses connected to this network.

11. The method as claimed in claim 1, wherein the traffic analyzer comprising at least one antenna, the gain and/or the directivity of this antenna is chosen so as to cover the given geographical area.

12. The method as claimed in claim 1, wherein the one or more indicators representative of the activity of a terminal is detected continuously for a given measurement time, during which the count of the number of these indicators is incremented, the method comprising a step of decrementing this count when the measurement time has elapsed.

13. The method as claimed in claim 12, wherein the count of the number of indicators representative of the activity of a terminal is decremented by reinitializing the count.

14. The method as claimed in claim 12, wherein the count of the number of indicators representative of the activity of a terminal is decremented by decrementing the count by a predefined number.

15. The method as claimed in claim 1, wherein the given geographical area is a moving area.

16. The method as claimed in claim 1, wherein the given geographical area is a non-moving area.

17. A method for detecting a flow of people between at least two nearby geographical areas, a network analyzer being placed in each of the areas, the method comprising the steps of:
estimating the number of people present and/or cellular terminals in each of said areas by applying at the very least steps (a) and (b) of the method as claimed in claim 1,
comparing the estimated values in each of the areas in order to deduce therefrom the orientation and/or the intensity of the flow of people between the two areas.

18. A device for estimating the number of people present in a given geographical area, at least some of these people being equipped with cellular terminals communicating on at least one network, the terminals communicating in accordance with at least two predefined communication standards, the device comprising:
a local receiver comprising a traffic analyzer for listening to the traffic on at least one network and for determining the number and the nature of the unencrypted messages transiting thereon,
a circuit for processing data from the receiver, configured so as to:
(a) detect, from an analysis of the traffic on the one or more networks present in said predefined area, performed using at least the traffic analyzer located in this area and with a range chosen depending on the area to be covered and for each of said standards, at least one indicator representative of the activity of a terminal on this or these one or more networks and operating in accordance with at least one of said standards,
(b) deduce, from the indicators thus detected, a count of the number of cellular terminals present in the area,
(c) estimate the number of people present in said area, based at least on a correlation law between the number of cellular terminals thus counted and the corresponding number of people present in said area,
the traffic analysis comprising detecting an indicator corresponding to a response to a random access request from a cellular terminal.

19. A vehicle or a public reception room equipped with a device as claimed in claim 18, the antenna is configured such that its coverage substantially coincides with the extent of the area of the vehicle or the room receiving people.
